(19) United States
(12) Patent Application Publication
(10) Pub. No.: US 2015/0061811 A1
(43) Pub. Date: Mar. 5, 2015

(54) COIL COMPONENT

(71) Applicant: TDK Corporation, TOKYO (JP)

(72) Inventors: Nobuo TAKAGI, TOKYO (JP); Setu TSUCHIDA, Yamagata (JP); Tasuku MIKOGAMI, TOKYO (JP); Satoru SARIISHI, TOKYO (JP)

(73) Assignee: TDK CORPORATION, TOKYO (JP)

(21) Appl. No.: 14/475,183

(22) Filed: Sep. 2, 2014

(30) Foreign Application Priority Data
Sep. 3, 2013 (JP) 2013-182084

(51) Int. Cl. H01F 27/29

(52) U.S. Cl. CPC H01F 27/292
USPC 336/192

(57) ABSTRACT

A coil component is provided with a coil, a base supporting the coil having a first surface parallel to an extending direction of the terminal section of the coil, and a terminal electrode having a first terminal portion printed on the first surface of the base. The first surface has a stepped surface including an upper stage surface and a lower stage surface. The first terminal portion has a stepped shape including an upper stage portion formed on the upper stage surface and a lower stage portion formed on the lower stage surface. The upper stage portion has a first terminal surface contacting the terminal section of the coil. The lower stage portion has a second terminal surface positioned on an extension line of the terminal section of the coil and not contacting the terminal section of the coil.

### BACKGROUND OF THE INVENTION

1. Field of the Invention

The present invention relates to a coil component and, more particularly, to a terminal electrode structure of a surface-mount type coil component.

2. Description of Related Art

Along with recent miniaturization of electronic devices, a coil component is required to foe mounted in high density, as other components are required to do so. For example, Japanese Patent Application Laid-Open No. 2009-117627 discloses a surface-mount type coil component capable of achieving high density mounting.

This coil component includes a core having a winding core and flanges, an insulating case in which an accommodation space for accommodating the core is formed, a terminal electrode made of a metal fitting and mechanically fixed to the case in a state where at least a part thereof is exposed outside, and a winding (wire) connected to the terminal electrode and wound, around the winding core via the case. The accommodation space for the core is defined by including a bottom surface substantially parallel with a mounting surface. The winding core and flange have a lower surface of the winding core and a lower surface of the flange, respectively, which are opposed to the bottom surface of the case. The lower surface of the winding core is in the same plane as the lower surface of the flange. A leg portion protruding toward the mounting surface is defined in a position opposite to the flange of the case, and a mounting portion of the terminal electrode is arranged in the leg portion.

In the above-described coil component, the wire end terminal electrode are connected in such that a leading end section of the wire is thermocompression-bonded on the terminal electrode. When the wire is thermocompression-bonded on the terminal electrode, a material (Cu) of the wire and a plating film (Ni and Sn) on a surface of the terminal electrode react with each other to form an alloy layer. The alloy layer has a high melting point, so that when a portion of the alloy layer serves as a solder bonding surface upon mounting of the coil component on a circuit board, solder wettability may be lowered. Particularly, as illustrated in FIG. 9A, when a leading end section 20e of a wire 20 to be thermocompression-bonded is made to be aligned to an end portion of a terminal, surface of a terminal electrode 21, the alloy layer is formed from end to end of the terminal surface in a wire extending direction, that is, formed over a wide area of the terminal surface and, at the same time, a plating thickness of a side electrode is reduced, which may inhibit formation of a solder fillet to cause mounting failure.

To solve this problem, as illustrated in FIG. 9B, the leading end section 20e of the wire 20 is made to be aligned not to the end portion of the terminal surface of the terminal electrode 21, but to a position (in the vicinity of a center of the terminal surface) inward from the end portion. In this case, the wire 20 led out from the winding core of the core passes the terminal surface of the terminal electrode 21 to be led frontward thereof in the wire extending direction. Then, a wire section (section denoted by a continuous line) located rearward (in the wire extending direction) of a position to be set as the wire leading portion is thermocompression-bonded, and a front wire section (section denoted by a dashed line) in the wire extending direction is out for removal. However, if the front wire section is brought into contact with the terminal surface of the terminal electrode 21, the wire is disadvantageously fixed to the surface of the terminal electrode 21 due to melting of the plating film on the surface of the terminal electrode by heat generated upon the thermocompression bonding, making it difficult to cut and remove the front wire section. Such a problem occurs not only when the metal fitting is used as the terminal electrode, but also when a printed electrode is used as the terminal electrode, and there is required a countermeasure against this problem.

### SUMMARY

To solve the above problem, a coil component according to the present invention includes a coil having a winding wire, a base supporting the coil, and a terminal electrode to which a terminal section of the coil is connected. The base has a first surface parallel to an extending direction of the terminal section of the coil. The terminal electrode has a first terminal portion printed on the first surface of the base. The first surface has a stepped surface including an upper stage surface and a lower stage surface. The first terminal portion has a stepped shape including an upper stage portion formed on the upper stage surface and a lower stage portion formed on the lower stage surface. The upper stage portion has a first terminal surface contacting the terminal section of the coil. The lower stage portion has a second terminal surface positioned on an extension line of the terminal portion and not contacting the terminal section of the coil.

According to the present invention, upon thermocompression bonding, the terminal portion of the wire is thermocompression-bonded only onto the first terminal surface of the first terminal portion of the terminal electrode and is not thermocompression-bonded onto the second terminal surface, preventing an alloy layer from being formed in a wide area. This prevents formation of a solder fillet from being inhibited due to existence of the alloy layer. Further, it is possible to reliably and easily cut and remove the wire after the thermocompression bonding.

In the present invention, it is preferable that the base has a second surface perpendicular to the first surface, the terminal electrode is formed into an L-shape and has a second terminal portion printed on the second surface of the base, and the second terminal portion is connected to the lower stage portion of the first terminal portion. With this configuration, the lower stage portion of the first terminal portion is not alloyed upon thermocompression bonding of the wire terminal section, so that it is possible to prevent a situation in which the solder fillet is hardly formed on the second terminal portion due to influence of alloying of the first terminal portion.

In the present invention, it is preferable that the base is a drum core having a winding core around which the coil is wound and a pair of flanges provided at both ends of the winding core, and the terminal electrode is formed on each of the flanges. With this configuration, in a surface-mount type coil component using the drum core, wettability of a solder on the terminal surface to which the wire is connected can be enhanced, thereby enhancing reliability of the coil component in terms of electrical and mechanical connection.

According to the present invention, an unnecessary section of the wire after thermocompression bonding can be reliably cut and easily removed. Thus, a coil component having a terminal surface with satisfactory solder wettability can be achieved.

### BRIEF DESCRIPTION OF THE DRAWINGS

The above and other objects, features and advantages of this invention will become more apparent by reference to the following detailed description of the invention taken in corn auction with the accompanying drawings, wherein:

FIG. 1 is a schematic perspective view illustrating an enter appearance of a surface-mount type coil component according to a first embodiment of the present invention;

FIG. 2 is an exploded perspective view of the coil component of FIG. 1;

FIG. 3 is a schematic perspective view obtained by turning upside down the coil component of FIG. 1;

FIG. 4 is a schematic perspective view illustrating a configuration of the drum core 2 in a state where the terminal electrodes 6a to 6f are provided thereon;

FIG. 5 is a schematic perspective view obtained by turning upside down the drum core 2 of FIG. 4, which illustrates a state where the terminal electrodes 6a to 6f are not provided thereon;

FIG. 6A is a schematic plan view of the flange 4A as viewed from the bottom thereof;

FIG. 6B is a schematic plan view of the flange 4A as viewed from the outer side surface side thereof;

FIGS. 7A is a schematic side cross-sectional view illustrating a shape of each of the terminal electrodes 6a to 6f provided on the flange 4A or 4B;

FIG. 7B is a partially enlarged view of the terminal electrode on the flange 4A side;

FIGS. 8A to 8C are exemplary views for explaining a thermocompression bonding process of the terminal section of the coil 7; and

FIGS 9A and. 9B are schematic diagrams for explaining a conventional coil component.

### DETAILED DESCRIPTION OF THE EMBODIMENTS

Preferred embodiment of the present invention will be described hereinafter in detail with reference to the accompanying drawings.

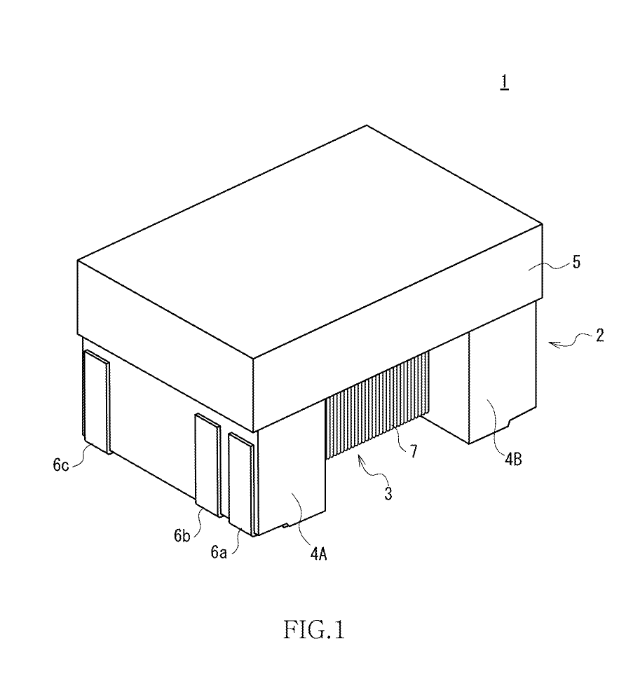

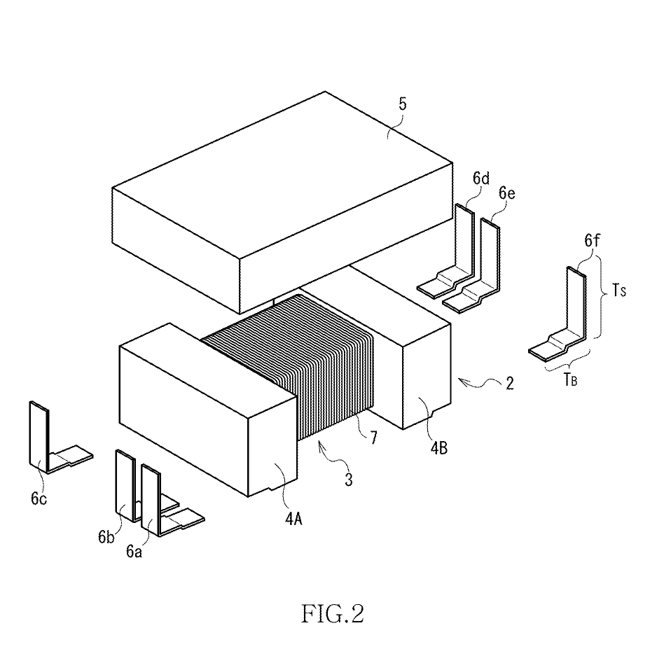

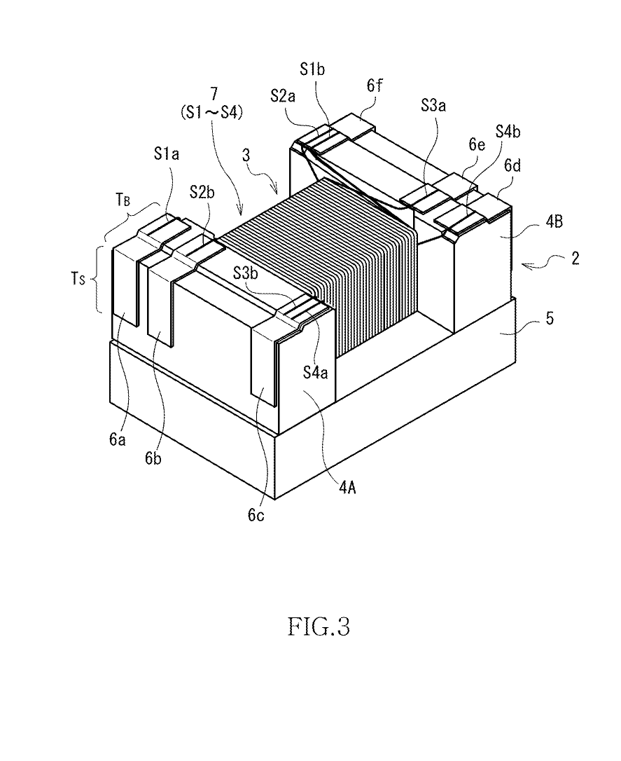

FIG. 1 is a schematic perspective view illustrating an outer appearance of a surface-mount type coil component according to a first embodiment of the present invention. FIG. 2 is an exploded perspective view of the coil component of FIG. 1, and FIG. 3 is a schematic perspective view obtained by turning upside down the coil component of FIG. 1.

As illustrated in FIGS. 1 to 3, a coil component 1 includes a drum core 2, a plate core 5, six terminal electrodes 6a to 6f and coils 7 composed of wires wound around the drum core 2. Although not especially limited, the coil component 1 is a surface-mount type pulse transformer and has a size of about 4.5 mm×3.2 mm×2.6 mm.

The drum core 2 is made of a magnetic material such as Ni—Zn based ferries and includes a winding core 3 around which the coils 7 are wound and a pair of flanges 4A and 4B located at both ends of the winding core 3. The plate core 5 is also made of a magnetic material such as Ni—Zn based ferrite. The plate core 5 is placed on upper surfaces of the respective flanges 4A and 4B and fixed thereto by adhesive or the like.

An upper surface of the plate core 5 is a flat smooth surface, so that the smooth surface can be used as an adsorption surface upon mounting of the coil component 1. Further, a surface of the plate core 5 to be bonded to upper surfaces of the flanges 4A and 4B is preferably a smooth surface. Abutment of the smooth surface of the plate core 5 against the flanges 4A and 4B allows the plate core 5 and flanges 4A and 4B to be securely adhered with each other, thereby forming a closed magnetic path free from magnetic leakage.

The terminal electrodes 6a to 6f are each an L-shaped printed electrode extending from a bottom surface of the flange 4A or 4B to an outer side surface thereof. The outer side surface of the flange refers to a surface positioned at an opposite side to a mounting surface for the winding core 3. The terminal electrodes 6a to 6f can be formed by applying a conductive paste and then firing the conductive paste followed by sequential formation of Ni and Sn plating films.

Three terminal electrodes 6a, 6b, 6c are provided at the flange 4A side, and the remaining three terminal electrodes 6d, 6e, 6f are provided at the flange 4B side. At the flange 4A side, two terminal electrodes 6a and 6b are provided at a right side of the flange 4A, terminal electrode 6c is provided at a left side thereof, and a certain insulating clearance is provided between the two terminal electrodes 6a, 6b and terminal electrode 6c. Similarly, at the flange 4B side, two terminal electrodes 6d and 6e are provided at a right side of the flange 4B, terminal electrode 6f is provided at a left side thereof, and a certain insulating clearance is provided between the two terminal electrodes 6d, 6e and terminal electrode 6f.

As illustrated in FIG. 2, the L-shaped terminal electrodes 6a to 6f each include a bottom surface portion T_{B} (first terminal portion) contacting the bottom surface (first surface) of the flange 4A or 4B and a side surface portion T_{S} (second terminal, portion) contacting the outer side surface (second surface) of the flange 4A or 4B. As illustrated in FIG. 3, terminal sections of the coils 7 are thermocompression-bonded onto surfaces of the bottom surface portions T_{B} of the terminal electrodes 6a to 6f, respectively.

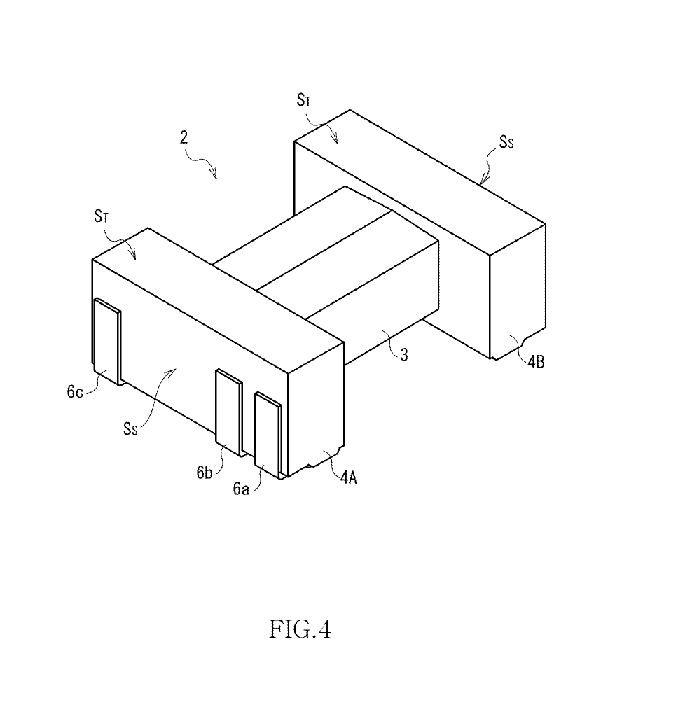

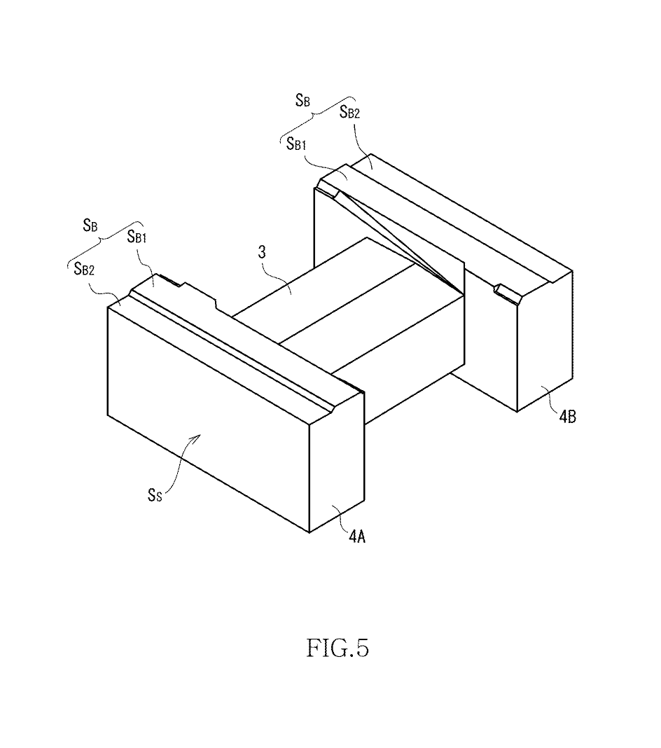

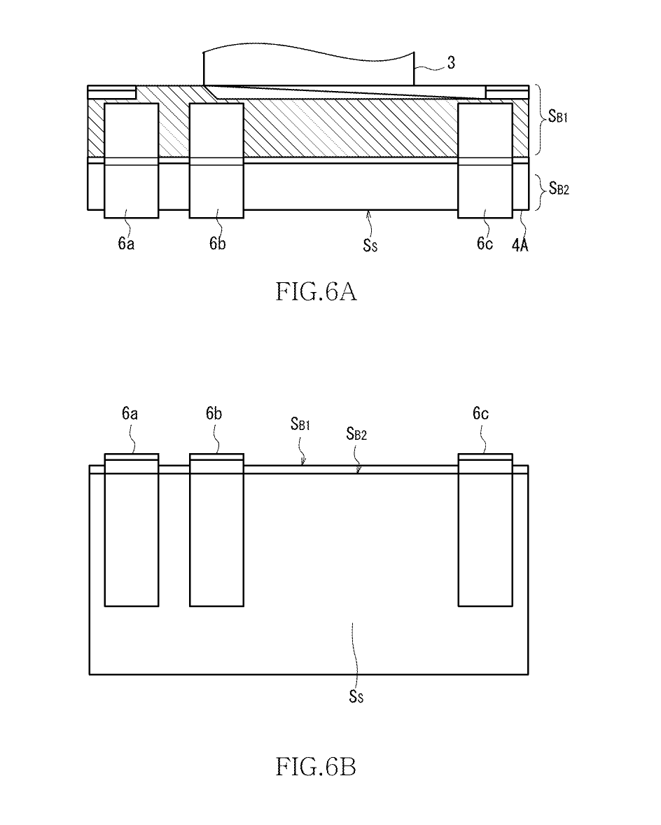

FIG. 4 is a schematic perspective view illustrating a configuration of the drum core 2 in a state where the terminal electrodes 6a to 6f are provided thereon. FIG. 5 is a schematic perspective view obtained by turning upside down the drum core 2 of FIG. 4, which illustrates a state where the terminal electrodes 6a to 6f are not provided thereon. FIG. 6A is a schematic plan view of the flange 4A as viewed from the bottom thereof, and FIG. 6B is a schematic plan view of the flange 4A as viewed from the outer side surface side thereof.

As illustrated in FIGS. 4 end 5, the drum core 2 includes the winding core 3 and pair of flanges 4A and 4B located at the both ends of the winding core 3. The drum, core 2 has a rotationally symmetric shape in a plan view. The flanges 4A and 4B have the same shape, so that in FIG. 6, only the flange 4A is illustrated, and the illustration of the flange 4B is omitted.

As illustrated in FIG. 4, each upper surface S_{T} of the flanges 4A and 4B is a smooth flat surface, which enhances adhesion with the plate core 5. As described above, the plate core 5 is bridged between the upper surfaces S_{T} of the flanges 4A and 4B, whereby a substantial closed magnetic path is formed.

As illustrated in FIGS. 4, 5, and 6B, each outer side surface S_{S} of the flanges 4A and 4B is a fiat surface. On the other hand, as illustrated in FIGS. 5 and 6A, each bottom surface S_{B} of the flanges 4A and 4B has a stepped surface in which an installation area for the terminal electrodes 6a to 6f on a base end side thereof is formed higher in height than an installation area for the terminal electrodes 6a to 6f on a leading end side thereof. More specifically, upper stage surfaces S_{B1} are formed near inner side surfaces of the respective flanges 4A and 4B, and lower stage surfaces S_{B2} are formed near outer side surfaces S_{S} thereof. In the present embodiment, the upper stage surfaces S_{B1} and lower stage surfaces S_{B2} are formed over the entire bottom surfaces S_{B} of the flanges 4A and 4B in a longitudinal direction thereof (entire areas of the respective flanges 4A and 4B in a width direction thereof). The base end side of the bottom surface portion T_{B} of each of the terminal electrodes 6a to 6f is provided on the upper stage surface S_{B1} of the bottom surface S_{B} of the flange 4A or 4B, and a corner side of the bottom surface portion T_{B} of each of the terminal electrodes 6a to 6f is provided on the lower stage surface S_{B2} of the bottom surface S_{B} of the flange 4A or 4B. In FIG. 6A, a hatched area is the upper stage surface S_{B1} and an unhatched area is the lower stage surface S_{B2}.

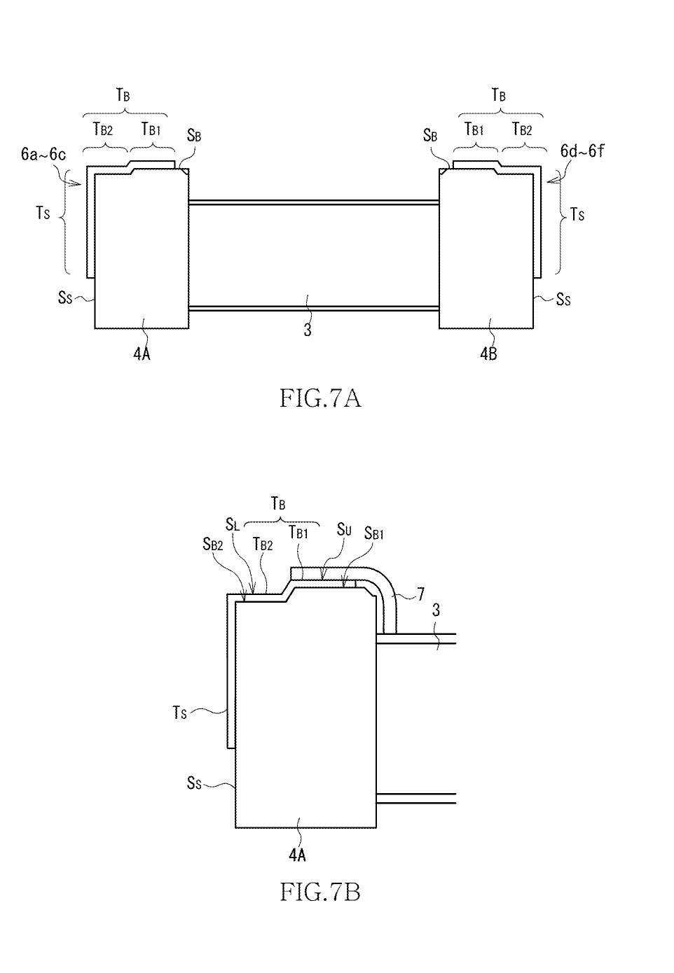

FIGS. 7A and 7B are schematic side cross-sectional views illustrating a shape of each of the terminal electrodes 6a to 6f provided on the flange 4A or 4B. FIG. A is a schematic side view including the entire drum core, and FIG. 7B is a partially enlarged view of the terminal electrode on the flange 4A side. A configuration on the flange 4B side is the same as that on the flange 4A side.

As illustrated in FIGS. 7A and 7B, the bottom and side surface portions T_{B} and T_{S} of each of the L-shaped terminal electrodes 6a to 6f are provided respectively on the bottom surface S_{B} (first surface) and outer side surface S_{S} (second surface) of the flange 4A or 4B. The bottom surface S_{B} of each of the flanges 4A and 4B has the stepped surface, and the bottom surface portion T_{B} of each of the terminal electrodes 6a to 6f has a stepped shape corresponding to the stepped surface of the bottom surface S_{B} of each of the flanges 4A and 4B.

The bottom surface portion T_{B} of each of the terminal electrodes 6a to 6f includes an upper stage portion T_{B1} formed near the inner side surface (near the winding core 3) of the flange 4A or 4B and a lower stage portion T_{B2} formed near the outer side surface S_{S} of the flange 4A or 4B. The side surface portion T_{S} is connected to the lower stage portion T_{B2} of the bottom surface portion T_{B}. The upper stage portion T_{B1} serves as a portion providing a terminal surface (first terminal surface S_{U}) contacting the terminal section of the coil 7, and the lower stage portion T_{B2} serves as a portion providing a terminal surface (second terminal, surface S_{L}) not contacting the terminal section of the coil 7. That is, the second, terminal surface S_{L} of the lower stage portion T_{B2} and first terminal surface S_{B} of the upper stage portion T_{B1} do not form the same plane.

The first terminal surface S_{U} of the bottom surface portion T_{B} of each of the terminal electrodes 6a to 6f provides a “press-contact surface” that receives press-contact force from the terminal section of the coil 7 upon thermocompression bonding. The second terminal surface S_{L} of the bottom surface portion T_{B} of each of the terminal electrodes 6a to 6f provides a “non press-contact surface” that releases press-contact force from the terminal section of the coil 7. The bottom surface portion T_{B} of each of the terminal electrodes 6a to 6f has the stepped surface constituted by the first terminal surface S_{U} and second terminal surface S_{L}, making it possible to prevent the terminal section of the coil 7 from being thermocompression-bonded over the entire width of the coil in the extending direction on the bottom surface portion of each of the terminal electrodes 6a to 6f. This allows an area where the alloy layer caused due to reaction between the wire and plating film is not formed to be secured widely, making it possible to reliably and easily cut and remove the wire.

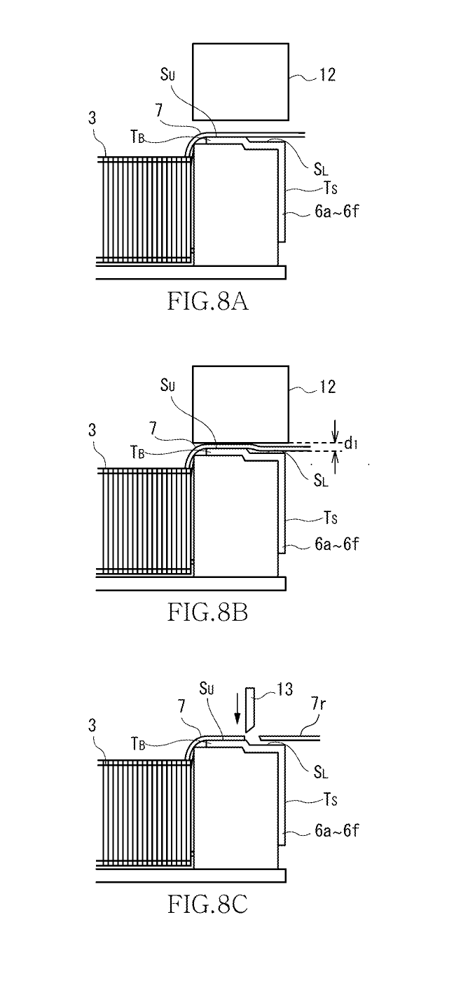

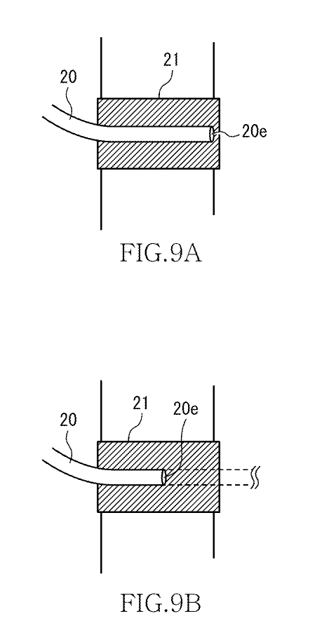

FIGS. 8A to 8C are exemplary views for explaining a thermocompression bonding process of the terminal section of the coil 7.

In the thermocompression bonding process, as illustrated in FIG. 8A, the terminal section of the coil 7 wound around the winding core 3 of the drum core 2 is wired on corresponding one of the terminal electrodes 6a to 6f . The terminal section of the coil 7 passes the corresponding terminal electrode and extends in parallel to the bottom surface of the flange 4A or 4B to be led to an outside of the flange 4A or 4B.

Then, as illustrated in FIG. 8B, a heater chip 12 is used to thermocompression bond the terminal section of the coil 7 onto the corresponding one surface of the terminal electrodes 6a to 6f. The wire section located above the first terminal surface S_{U} of the bottom surface portion T_{B} of each of the terminal electrodes 6a to 6f is sandwiched between the heater chip 12 and first terminal surface S_{U} to foe pressed against the terminal surface by press-contact force of the high-temperature heater chip 12, with the result that the material (Cu) of the wire and plating film (Ni and Sn) of the terminal surface are alloyed to obtain sufficient bonding force.

On the other hand, the wire section located above the second terminal surface S_{L} of the bottom surface portion T_{B} of each of the terminal electrodes 6a to 6f enters a gap d₁ between the heater chip 12 and second terminal surface S_{L}. Thus, unlike the first terminal surface S_{U}, sufficient press-contact force is not applied to the second terminal surface S_{L}. As a result, thermocompression bonding of this wire section onto the second terminal surface S_{L} can be avoided.

As illustrated in FIG. 8C, the terminal section of the coil 7 thus thermocompression-bonded onto the corresponding one of the terminal electrodes 6a to 6f is cut by a cutter 13 to be adjusted in length. At this time, the coil 7 is cut at a position around the stepped portion formed on the corresponding one of the terminal electrodes 6a to 6f. Upon cutting of the terminal section of the coil 7, an extra wire section 7r of the wire that has not been subjected to thermocompression boding is not fixed to the terminal surface. If the extra wire section 7r is fixed to the terminal surface by the plating film melted upon thermocompression bonding, fixing force therebetween is weak, so that the extra wire section 7r can be separated from the terminal surface by application of slight force. As a result, the wire is thermocompression-bonded only onto the first terminal surface S_{U} out of the surface of the bottom surface portion T_{B} of the terminal electrode, while the wire is not present on the second terminal surface S_{L}.

On the first terminal surface S_{U},an area around the wire is lowered in solder wettability; however, there exists an area that has not been alloyed around the low solder wettability area, which contributes to solder connection. On the other hand, on the second terminal surface S_{L}, the wire is not present and thus has not been alloyed, so that satisfactory solder wettability is obtained.

The second terminal surface is a portion contacting the side surface portion T_{S} of the terminal electrode and contributing, together with the side surface portion T_{S}, to formation of a solder fillet upon surface mounting. The second terminal surface S_{L} not alloyed, so that it is possible to prevent a situation in which the Sn plating film on the side surface portion T_{S} is melted by heat upon the thermocompression bonding to flow to the bottom surface portion T_{B} side to result in reduction in thickness of the side surface portion T_{S}. Thus, when the coil component 1 having the configuration described above is surface-mounted, the solder wettability with respect to the terminal electrodes 6a to 6f can be enhanced, and the solder fillet can be reliably formed from the lower stage portion T_{B2} to side surface portion T_{S}. Thus, reliability of the coil component 1 in terms of electrical and mechanical connection can be enhanced.

As described above, the coil component 1 according to the present embodiment has a configuration in which the stepped surface is formed on the terminal surface of each of the terminal electrodes 6a to 6f to which the terminal section of the coil is connected so as to prevent the terminal surface from contacting the leading end section of the coil 7, thereby preventing the leading end of the wire from being thermocompression-bonded onto the terminal surface, which in turn makes it possible to reliably and easily cut and remove the wire after the thermocompression bonding. Further, it is possible to prevent reduction in the plating thickness of the side surface portion T_{S} upon thermocompression bonding, which in turn prevents formation of the solder fillet from being inhibited.

It is apparent that the present invention is not limited to the above embodiments, but may be modified and changed without departing front the scope and spirit of the invention.

For example, although a lateral drum core including the winding core around which the coil is wound and pair of flanges provided at the both ends of the winding core is used as a base in the above embodiment, so-called a vertical drum core may be used. The number of the terminal electrodes to be mounted is not especially limited. Thus, for example, four terminal electrodes may be formed on each of the flanges 4A and 4B.

What is claimed is:

1. A coil component comprising:
a coil having a winding wire;
a base supporting the coil; and
a terminal electrode to which a terminal section of the coil is connected, wherein
the base has a first surface substantially parallel to an extending direction of the terminal section of the coil,
the terminal electrode has a first terminal portion printed on the first surface of the base,
the first surface has a stepped surface including an upper stage surface and a lower stage surface,
the first terminal portion has a stepped shape including an upper stage portion formed on the upper stage surface and. a lower stage portion formed on the lower stage surface,
the upper stage portion has a first terminal surface contacting the terminal section of the coil,
the lower stage portion has a second terminal surface positioned on an extension line of the terminal section of the coil and not contacting the terminal section of the coil.

2. The coil component as claimed in claim 1, wherein
the base has a second -surface substantially perpendicular to the first surface,
the terminal electrode is formed into an L-shape and has a second terminal portion printed on the second surface of the base, and
the second terminal portion is connected to the lower stage portion of the first terminal portion.

3. The coil component as claimed in claim 1, wherein
the base is a drum core having a winding core around which the coil is wound and a pair of flanges provided at both ends of the winding core, and
the terminal electrode is formed on each of the flanges.

4. A coil component comprising;
a drum core having a winding core and a flange provided at an end of the winding core, the flange including a first plane having a first height from the winding core and a second plane having a second height from the winding core, the first height being greater than the second height;
a terminal electrode formed on the first and second planes of the flange; and
a coil wound around the winding core, the coil having a terminal section connected to the terminal electrode on the first plane of the flange so that the terminal section is free from contacting the second plane of the flange.

5. The coil component as claimed in claim 4, wherein the terminal electrode is continuously formed on the first and second planes of the flange.

6. The coil component as claimed in claim 5, wherein the second plane is positioned at an opposite side of the drum core with respect to the first plane.

7. The coil component as claimed in claim 6, wherein the terminal section of the coil is terminated at vicinity of a boundary between the first and second planes.

8. The coil component as claimed in claim 4, wherein
the flange further includes a third plane substantially perpendicular to the first and second plane,
the terminal electrode is formed on the first, second and third planes of the flange, and
the terminal electrode is continuously formed on the first, second and third planes of the flange.

9. The coil component as claimed in claim 4, wherein the terminal electrode is printed on the first and second planes of the flange.

10. A coil component comprising;
a drum core having a winding core and a flange provided at an end of the winding core, the flange including a first plane, a second plane substantially parallel to the first plane and a third plane substantially perpendicular to the first and second planes;
a terminal electrode continuously formed on the first, second and third planes of the flange, the terminal electrode having first, second, and third electrodes formed on the first, second and third planes of the flange, respectively, the second electrode being connected between the first and third electrodes; and
a coil wound around the winding core, the coil having a terminal section contacting the first electrode without contacting the second and third electrodes.

11. The coil component as claimed in claim 10, wherein the terminal section of the coil is terminated at vicinity of a boundary between the first and second planes.

12. The coil component as claimed in claim 10, wherein the terminal electrode is printed on the first, second and third planes of the flange.
